(19) United States
(12) Patent Application Publication
(10) Pub. No.: US 2013/0161153 A1
(43) Pub. Date: Jun. 27, 2013

(54) CONSUMER OPERATED KIOSK-BASED MARKETPLACE SYSTEMS AND ASSOCIATED METHODS

(71) Applicant: Coinstar, Inc., Bellevue, WA (US)

(72) Inventors: Engle Saez, Seattle, WA (US); Lisa Mason, Issaquah, WA (US); Sheleen Lepar, Bellevue, WA (US)

(73) Assignee: COINSTAR, INC., Bellevue, WA (US)

(21) Appl. No.: 13/728,905

(22) Filed: Dec. 27, 2012

Related U.S. Application Data
(60) Provisional application No. 61/580,604, filed on Dec. 27, 2011.

(51) Int. Cl. G06M 3/00

(52) U.S. Cl. CPC G06M 3/00
USPC 194/215

(57) ABSTRACT

Consumer operated kiosks for coin counting and/or providing various products and services are described herein. In various embodiments, the kiosks can provide the consumer with the ability to review and select various favorite options for utilizing coin value and other forms of value and to sort same. Other embodiments provide the ability for the user log in to a social networking website to share and compare their experiences on the kiosk with others via the social network.

### CROSS-REFERENCE TO RELATED APPLICATION(S) INCORPORATED BY REFERENCE

The present application claims priority to and the benefit of U.S. Provisional Patent Application No. 61/580,604, filed Dec. 27, 2011, and entitled “CONSUMER OPERATED KIOSK-BASED MARKETPLACE SYSTEMS AND ASSOCIATED METHODS,” which is incorporated herein in its entirety by reference.

### TECHNICAL FIELD

The present disclosure is generally related to consumer operated kiosk systems and associated methods for converting coin value, cash value, and/or other forms of value into various types of commercial instruments, services, products, and the like.

### BACKGROUND

Consumer-operated coin counting kiosks that offer redeemable cash vouchers and other forms of value in exchange for loose coins are known. Such kiosks can include, for example, the machines disclosed in: U.S. Pat. Nos. 7,971,699, 7,874,478, 7,520,374, 8,033,375 and 8,332,313; each of which is incorporated herein by reference in its entirety. Some of these machines count consumer coins and dispense redeemable cash vouchers, while others may offer other types of products and services such as pre-paid gift cards, prepaid phone cards, and/or “e-certificates.”

Vouchers can be redeemed for cash and/or merchandize at a point of sale (POS) in a retail establishment. E-certificates can enable the holder to purchase items online by inputting a code from the e-certificate when making the purchase. Prepaid gift cards can be used to make POS purchases by swiping the card through a conventional card reader, and prepaid phone cards can be used for making cell phone calls.

### BRIEF DESCRIPTION OF THE DRAWINGS

FIG. 1 is an isometric view of a kiosk for counting consumer coins and providing products and services in accordance with embodiments of the present technology.

FIG. 2 provides a schematic representation of a kiosk architecture configured in accordance with embodiments of the present technology.

FIG. 3 is a schematic diagram of a suitable computing environment for implementing various consumer operated kiosk systems in accordance with embodiments of the present technology.

FIG. 4 illustrates a representative display page suitable for selecting, sorting and/or managing kiosk-based marketplace options in accordance with an embodiment of the present technology.

FIG. 5 illustrates a representative display page associated with a user selection of a gift card marketplace option in accordance with an embodiment of the present technology.

FIG. 6A-6E illustrate a series of representative display pages suitable for sharing various aspects of a user's kiosk experience with one or more people at remote locations in accordance with embodiments of the present technology.

FIGS. 7A and 7B illustrate a series of representative display pages suitable for depositing funds directly into an online account with a kiosk configured in accordance with an embodiment of the present technology.

FIGS. 8A and 8B illustrate a series of representative display pages suitable for logging in to an account with a kiosk configured in accordance with embodiments of the present technology.

FIGS. 9A and 9B are representative flow diagrams of routines for performing kiosk based coin counting transactions in accordance with embodiments of the present technology.

### DETAILED DESCRIPTION

The following disclosure describes various embodiments of consumer operated kiosks and related systems for receiving coins and other types of funds and providing various products and services. The following disclosure also describes various embodiments of display pages and routines for providing access to accounts, to purchasing instruments (e.g., vouchers and gift cards), and/or to social networks, and for implementing various other functions with the kiosk systems described herein.

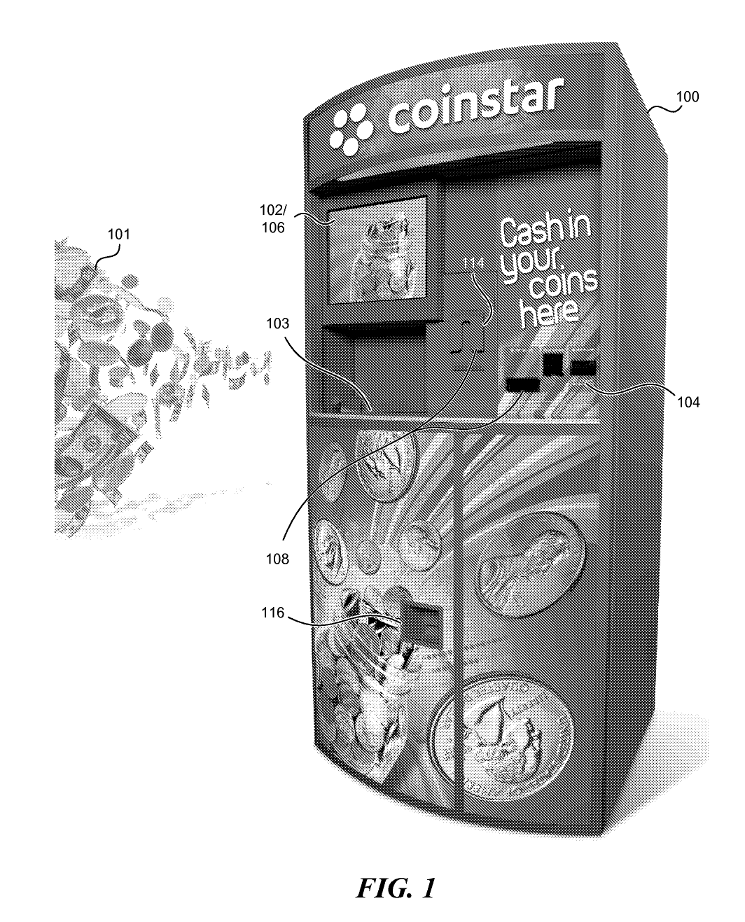

Certain details are set forth in the following description and in FIGS. 1-9B to provide a thorough understanding of various embodiments of the present technology. In other instances, well-known structures, materials, operations and/or systems often associated with, for example, consumer operated kiosks (e.g., coin counting kiosks), computers, and computer networks are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of particular embodiments of the present technology. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements facilitate the discussion of any particular element, the most significant digit or digits of any reference number refers to the Figure in which that element is first introduced. For example, element 110 is first introduced and discussed with reference to FIG. 1.

FIG. 1 is an isometric view of a consumer operated kiosk 100 for providing various consumer products and services in return for loose coins, paper currency, and/or other forms of monetary value in accordance with an embodiment of the present technology. In the illustrated embodiment coins, cash and/or other forms of currency and value 101 can be deposited in, for example, a coin input region 103 (e.g., a pivoting coin tray) of the kiosk 100. Paper money (e.g., bills), credit, debit, and other forms of funds can be deposited via, for example, a bill slot and a card reader, respectively (identified collectively at 104). The kiosk 100 can be generally similar in structure and function to kiosks disclosed in, and can include a coin counting apparatus for counting the deposited coins and determining a value as disclosed in, for example, U.S. Pat. No. 7,971,699, entitled “COIN COUNTER/SORTER AND COUPON/VOUCHER DISPENSING MACHINE AND METHOD;” U.S. Pat. No. 7,874,478, entitled “COIN COUNTER AND VOUCHER DISPENSING MACHINE AND METHOD;” U.S. Pat. No. 8,033,375, entitled “METHODS AND SYSTEMS FOR EXCHANGING AND/OR TRANSFERRING VARIOUS FORMS OF VALUE;” U.S. Pat. No. 8,332,313, entitled “METHODS AND SYSTEMS FOR EXCHANGING AND/OR TRANSFERRING VARIOUS FORMS OF VALUE;” U.S. Pat. No. 7,113,929, entitled “SYSTEM FOR VOUCHER OR TOKEN VERIFICATION;” and U.S. patent application Ser. No. 11/294,637, entitled “METHODS AND SYSTEMS FOR EXCHANGING AND/OR TRANSFERRING VARIOUS FORMS OF VALUE” and filed Dec. 5, 2005; each of which is incorporated herein in its entirety by reference.

Embodiments of the kiosk 100 can also include, for example, one or more output devices 108 (e.g., outlet slots for dispensing redeemable cash vouchers, e-certificates, prepaid cards, etc.), and one or more display devices 106 (e.g., a display screen, such as an LCD screen, video screen, etc.) for displaying various options and prompts to consumers and, in some embodiments, receiving user selections via an input device 102, such as a touch screen (not shown in detail in FIG. 1). Some embodiments of the kiosk 100 can also include a wireless facility (also not shown in FIG. 1) for wirelessly transferring funds (e.g., consumer coin value), offers, coupons, etc. to a wireless-enabled mobile device (e.g., a mobile computing device such as a smart phone) in proximity of the kiosk (e.g., within a distance suitable for near field communication (NFC)), as described in, for example, U.S. patent application Ser. No. 13/304,254, filed Nov. 23, 2011, and entitled “MOBILE COMMERCE PLATFORMS AND ASSOCIATED SYSTEMS AND METHODS FOR CONVERTING CONSUMER COINS, CASH, AND/OR OTHER FORMS OF VALUE FOR USE WITH SAME,” and U.S. patent application Ser. No. 13/367,129, filed Feb. 6, 2012, and entitled “COIN COUNTING MACHINES HAVING COUPON CAPABILITIES, LOYALTY PROGRAM CAPABILITIES, ADVERTISING CAPABILITIES, AND THE LIKE;” both of which are incorporated herein by reference in their entireties. Once the coin value or other funds have been transferred to a smart phone or other mobile device, the consumer can utilize the value for various types of mobile payment solutions. Such solutions can include, for example, purchasing goods and/or services at a retailer by scanning the mobile device by a terminal having the relevant NFC technology, by using suitable mobile commerce software known to those of ordinary skill in the art, and/or by implementing other known forms of mobile payment solutions. Such mobile commerce software and solutions can include software that enables use of “mobile wallets.”

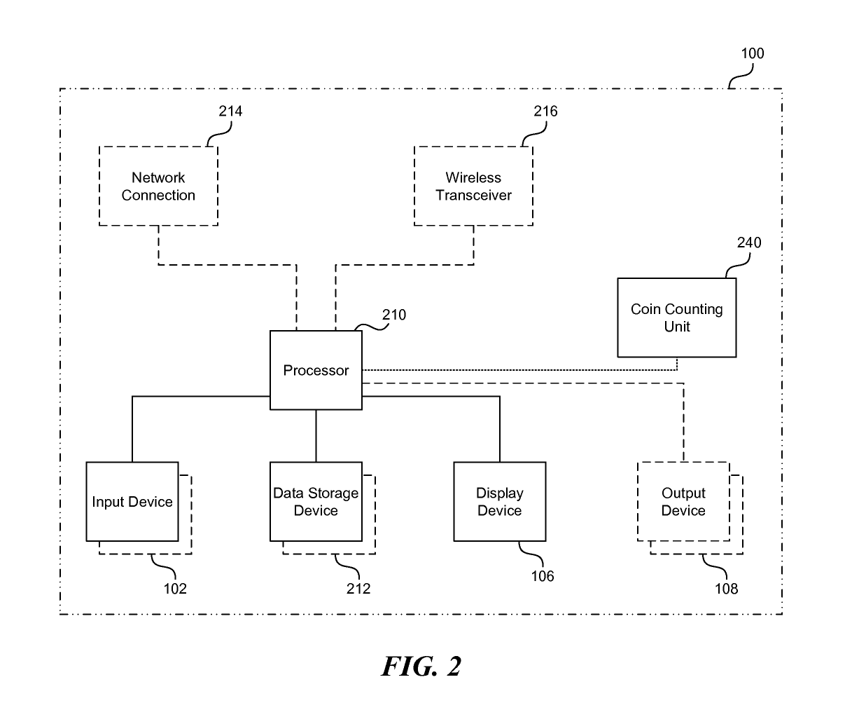

FIG. 2 provides a schematic representation of a kiosk architecture configured in accordance with embodiments of the present technology. In the illustrated embodiment, the kiosk 100 can include a suitable network connection 214 (e.g., a wired connection, such as a modem, cable, etc.), and a wireless transceiver 216, such as a transceiver suitable for wireless near field communication (e.g., Bluetooth communication) with a mobile device. The network connection 214 can enable the kiosk 100 to exchange information with one or more remote computers (e.g., one or more server computers), websites, etc., via a suitable communication link, network, the Internet, etc. The kiosk 100 can further include a suitable processor or central processing unit (CPU) 210 that controls one or more functions of the kiosk 100, including receiving information from a coin counting unit 240, the consumer input device 102 (e.g., a touch screen, key pad, etc.), a data storage device or memory 212, the display device 106 (e.g., a LCD screen), and/or the output device 108 (e.g., a visual and/or audio output device such as a display screen and speakers, respectively, a tactile output device for dispensing, for example, redeemable paper vouchers, receipts, e-certificates, cards and card facsimiles (e.g., wallet-sized prepaid cards), etc.) The CPU 210 may be any logic processing unit, such as one or more CPUs, digital signal processors (DSPs), application-specific integrated circuits (ASIC), etc. The system memory 212 can include read-only memory (“ROM”) and random access memory (“RAM”).

Unless described otherwise, the construction and operation of the various blocks shown in FIG. 2 are of conventional design. Accordingly, such blocks need not be described in further detail herein, as they will be readily understood by those skilled in the relevant art. In other embodiments, the kiosk 100 can include other or additional features that are different from those described above. In still further embodiments, the kiosk 100 can include more or fewer features similar to those described above.

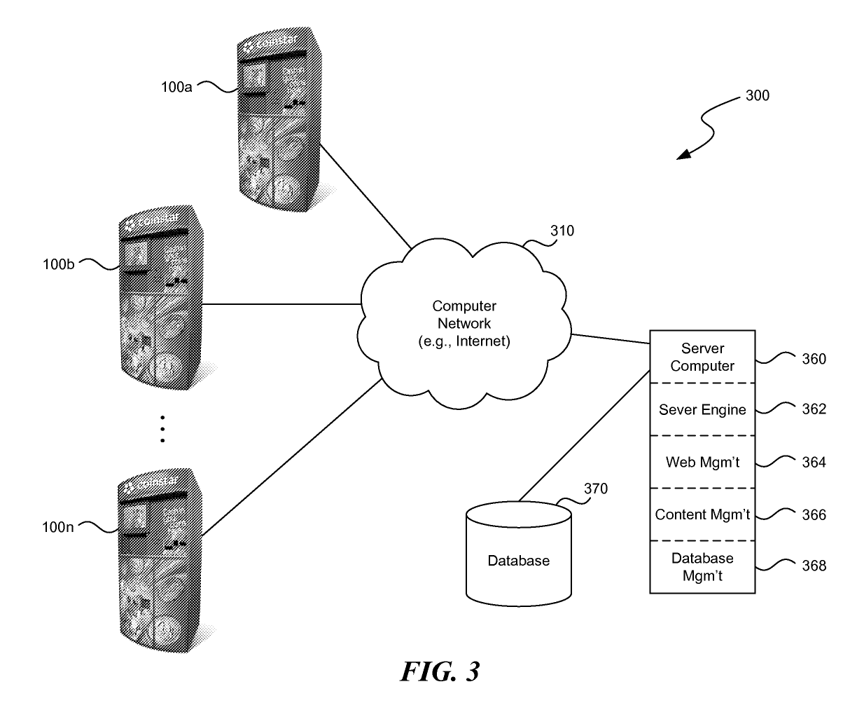

FIG. 3 is a schematic diagram of a suitable computing environment 300 in which one or more of the kiosk platforms described above (e.g., the kiosk 100) can be implemented in accordance with embodiments of the present technology. In the illustrated embodiment, the kiosks 100 can exchange information with one or more remote computers (e.g., one or more server computers 360) via a web interface that includes a communication link 310. Although a publicly available communication link 310 (e.g., the Internet) is shown in FIG. 3, a private network, such as an intranet or other network may likewise be used. Moreover, in some embodiments the individual kiosks 100 can be connected to a host computer (not shown) that facilitates the exchange of information between the kiosks 100 and remote computers.

The server computer 360 can perform much or all of the functions for receiving, routing and storing of electronic messages, such as web pages, audio signals and electronic images necessary to implement the commerce systems described above. The server computer 360 can retrieve and exchange web pages and other content with a database 370. In addition, in various embodiments the server computer 360 can include a server engine 362, a web page management component 364, a content management component 366, and a database management component 368. In various embodiments, the server engine 362 can perform the basic processing and operating system level tasks associated with the various technologies described herein. The web page management component 364 can handle creation and/or display and/or routing of web or other display pages. The content management component 366 can handle many of the functions in the mobile commerce embodiments described herein. The database management component 368 can include suitable storage and can perform suitable storage and retrieval tasks with respect to the database, query the database, and store various data such as animation, graphics, visual and audio signals, etc.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

One skilled in the relevant art will appreciate that the concepts of the invention can be used in various environments other than location based or the Internet. In general, a display description may be in WPF format, HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment. Although specific circuitry is described above, those or ordinary skill in the art will recognize that a micro processor-based system could also be used where any logical decisions are configured in software.

While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

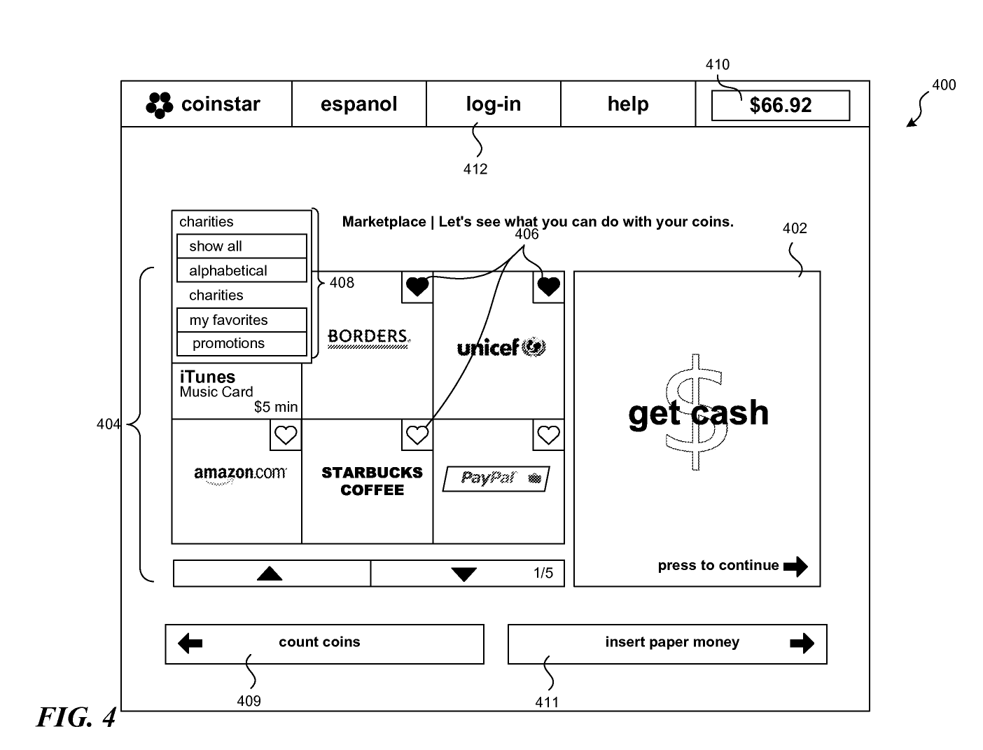

Referring to FIGS. 4 through 8B, representative computer displays or web pages will now be described with respect to assigning and managing tasks, such as for implementing various aspects of the consumer kiosk-based marketplace described herein. The screens of FIGS. 4 through 8B may be implemented in any of various ways, such as in C++ or as web pages in XML (Extensible Markup Language), HTML (HyperText Markup Language) or any other scripts or methods of creating displayable data, such as the Wireless Access Protocol (“WAP”). The screens or web pages provide facilities to present information and receive input data, such as a form or page with fields to be filled in, pull-down menus or entries allowing one or more of several options to be selected, buttons, sliders, hypertext links or other known user interface tools for receiving user input. While certain ways of displaying information to users is shown and described with respect to certain Figures, those skilled in the relevant art will recognize that various other alternatives may be employed. The terms “screen,” “web page,” “display page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database typically connected to a server. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

FIGS. 4-8B present various screenshots or display pages that can be implemented with the kiosk 100 described above to provide consumers with access to a wide variety of options for utilizing the value of their coins, cash, and/or other types of funds. The display pages can be presented to the user in response to the user inputting funds (e.g., coins), selecting an appropriate prompt, pressing a “start” button, and/or other ways. FIG. 4, for example, illustrates a display page 400 which can be displayed on, for example, the display device 106 (e.g., a display screen or video display) of the kiosk 100 shown in FIG. 1. The display page 400 can be presented to enable the user to view a list of options in an electronic “marketplace” and identify favorites. For example, the display page 400 includes an array of transaction options 404 that include: obtaining gift cards (e.g., a Borders®, iTunes®, or Starbucks® gift card), making a donation to a charity, purchasing an eCertificate (from, for example, Amazon.com®), and/or depositing money (e.g., coins, paper currency, credit, etc.) in (or withdrawing money from) an account, such as a PayPal® account or other online account. An additional option includes selecting a “get cash” icon or button 402 that enables the user to receive a redeemable cash voucher in return for their coins or other funds.

In one aspect of the illustrated embodiment, a favorite icon 406 (e.g., a heart shape) is associated with each of the marketplace options, and the user can select (e.g., via touching or with a suitable pointing device) the favorite icon 406 associated with a particular option to identify the option as a “favorite” of the user. The favorites are visually distinguished from other products/services offered in the marketplace by darkening of the favorite icon 406 after it has been selected. The user may also use a drop-down list 408 when they access the display page 400 to sort the different options in a preferred manner. For example, the user may elect to show all of the different marketplace options, to alphabetize the options, to only show charities, to only show options that have been identified as favorites, and/or to only show options associated with promotions. After the user has identified favorites and/or sorted the various options into a desired arrangement, the user can then select a “count coins” button 409 if the user then wishes to have coins counted, or an “insert paper money” button 411 if the user prefers to pay for all or a portion of the transaction with paper money. The user can also select to deposit their money and have it counted before going to the marketplace.

In the embodiment described above, the user is presented with a number of products/services options in a “marketplace” on the kiosk. In order to avoid or limit user confusion, the initial presentation of the many marketplace options can be ordered. A user can then re-order the list based on pre-defined methods (i.e. alphabetical), or sort/limit the number of options presented by selecting any number of different categories for display (e.g., charities, gaming options, gift cards, money transfers, etc.) at the kiosk 100. From this screen, the user can instantly add/remove a product/service as a favorite. Also, if the user retrieves more information regarding the product, they can add/remove the item from the list of favorites. After the user marks/selects preferred products from a display of products/services in a “marketplace” on one of the kiosks 100, the user-selected products can be stored on one or more networked servers (e.g., in the “cloud”) and then loaded on the kiosk 100 (or another kiosk in the network) the next time the user accesses their account. The selection of preferred products enables personalized sorting and filtering options in the marketplace on the kiosk. Further aspects of these embodiments can include:
If the user logs-in to one of the kiosks 100 (e.g., by inputting a username, password, code, a card (e.g., a credit card), etc.), and has previously registered and selected favorites, the previously selected favorites will be retrieved from a remote server (i.e. the cloud) and presented to the user.
If the user (who currently has a registration & selected favorites), selects additional favorites then logs-in to the kiosk—the favorites will be merged, presented to the user, and the on-line storage of the favorites will be updated.
A user (who has not registered) can register before or after selecting favorites on the kiosk. The favorite storage will be updated accordingly.
A user can also log-in to a website associated with the kiosk network via a remote computer (e.g., a personal computer or handheld device) to set/view/change favorites as well as to view what automated retail machines (e.g., what kiosks 100) offer the products and services associated with the selected favorites.

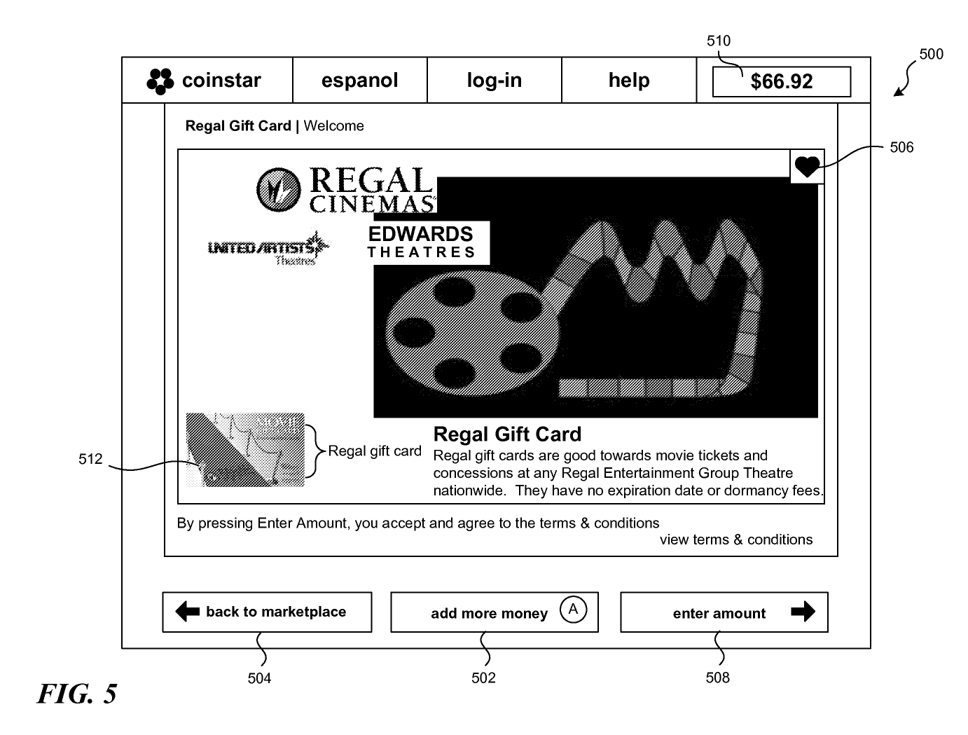

FIG. 5 illustrates a representative display page 500 that can be displayed to the user if the user selects (from, e.g., the display page 400) an option, for example, to receive a gift card for use at a cinema chain. The display page 500 illustrates the spending value at the user's disposal in a dollar amount field 510. The display page 500 also includes a “favorites” icon 506 for identifying the selected option as a favorite of the particular user. The display page 500 further includes an illustration of the gift card or gift card facsimile 512 that the user will receive in return for their funds. The user can select an amount to put on the card with an “enter amount” button 508. The user can also deposit additional funds for the card with an “add money” button 502. Selecting a “back” button 504 returns the user to the marketplace display page.

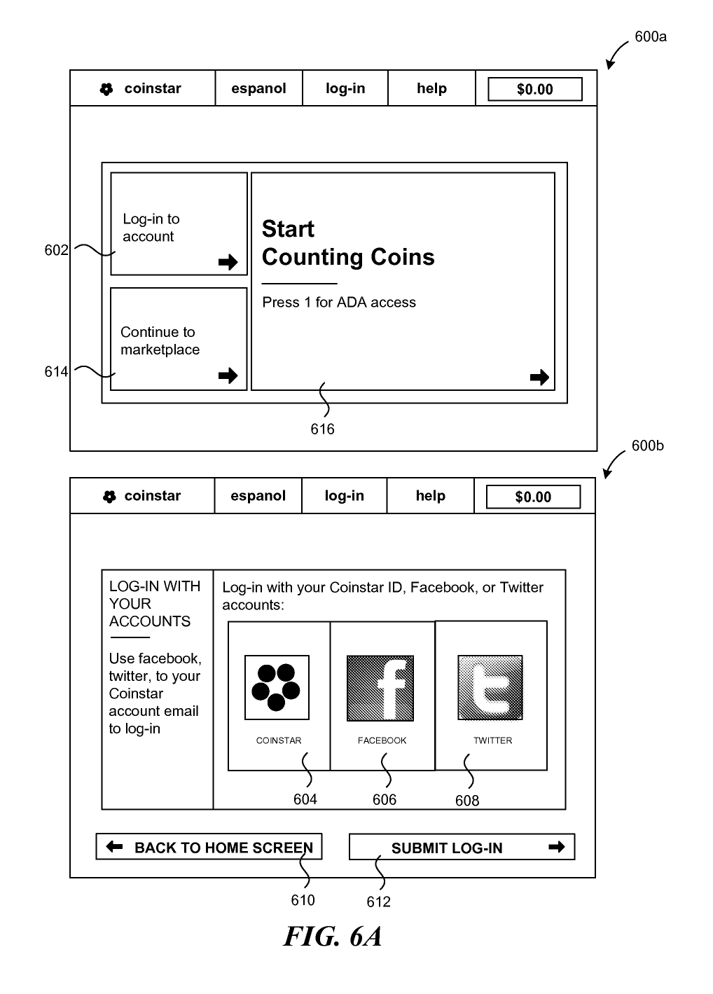

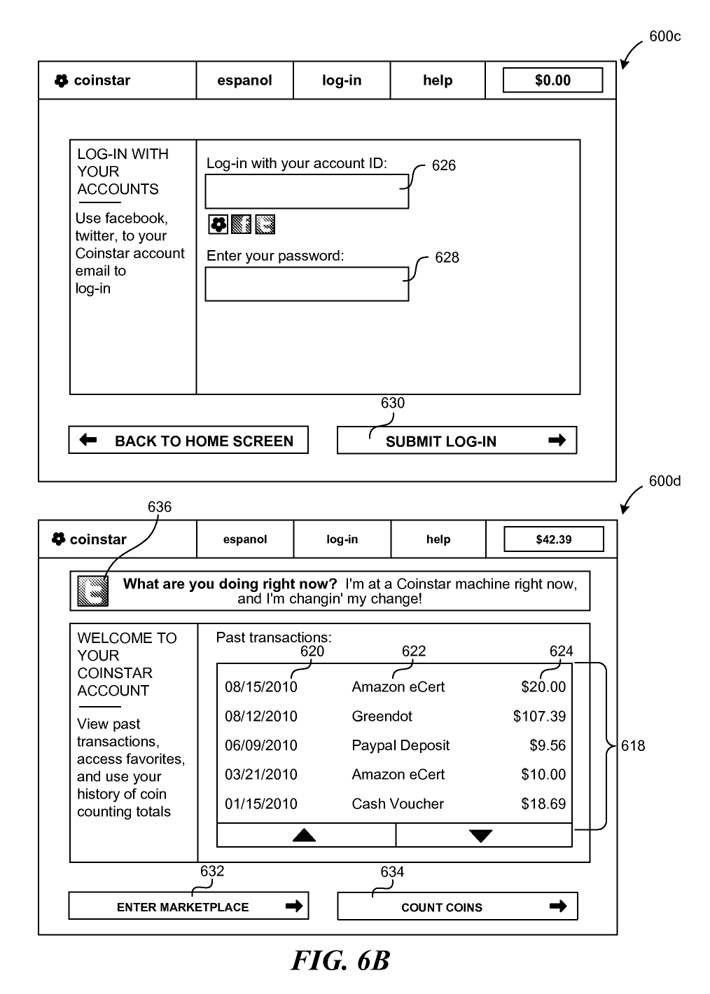

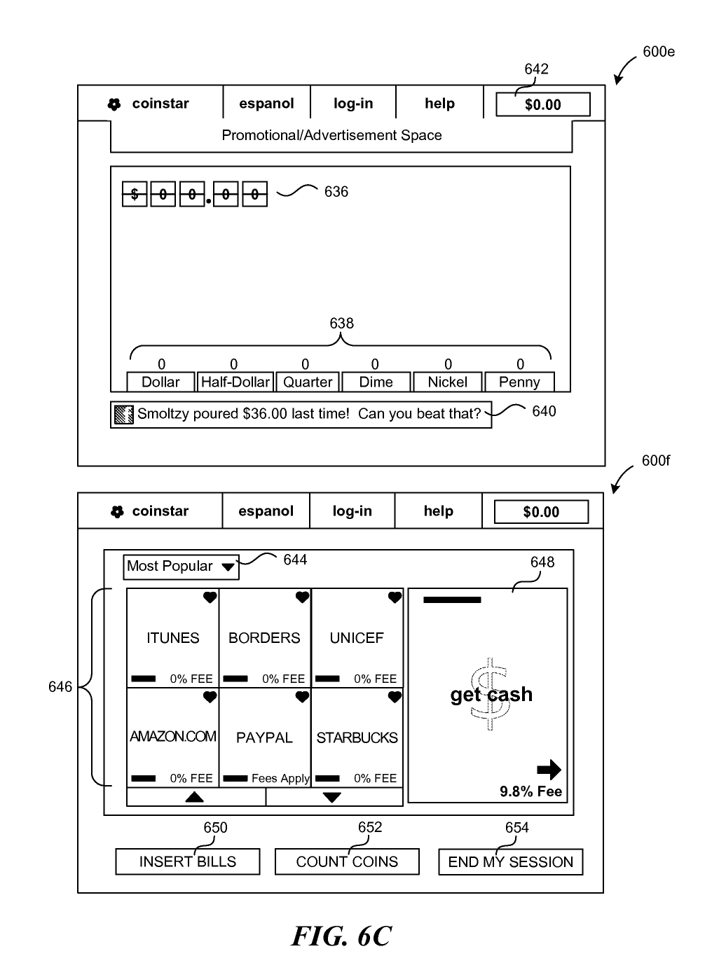

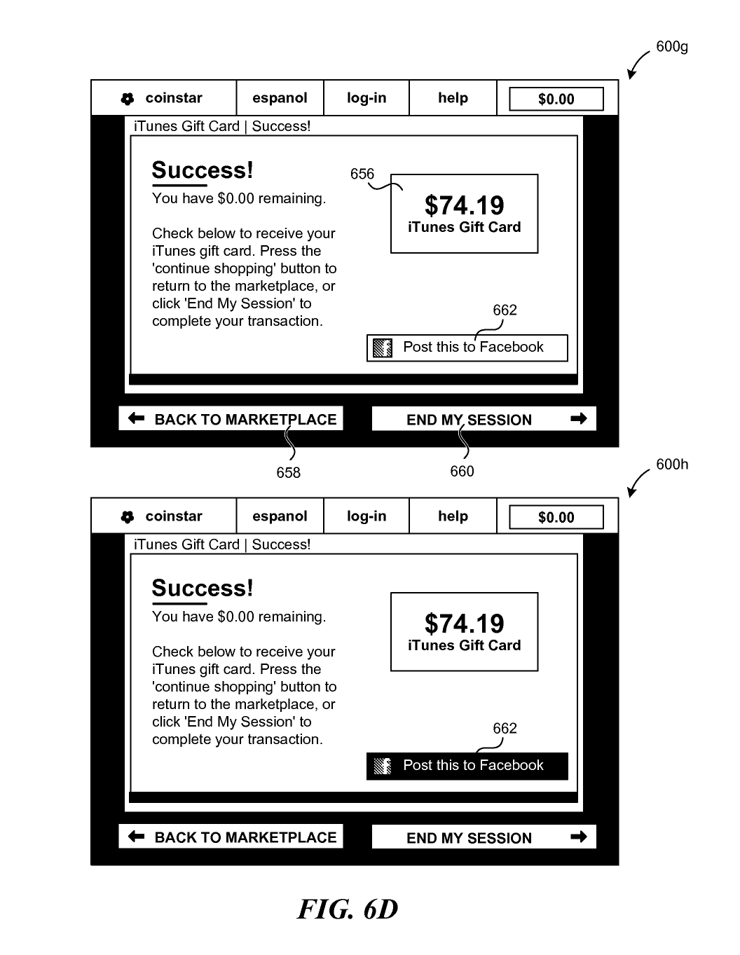

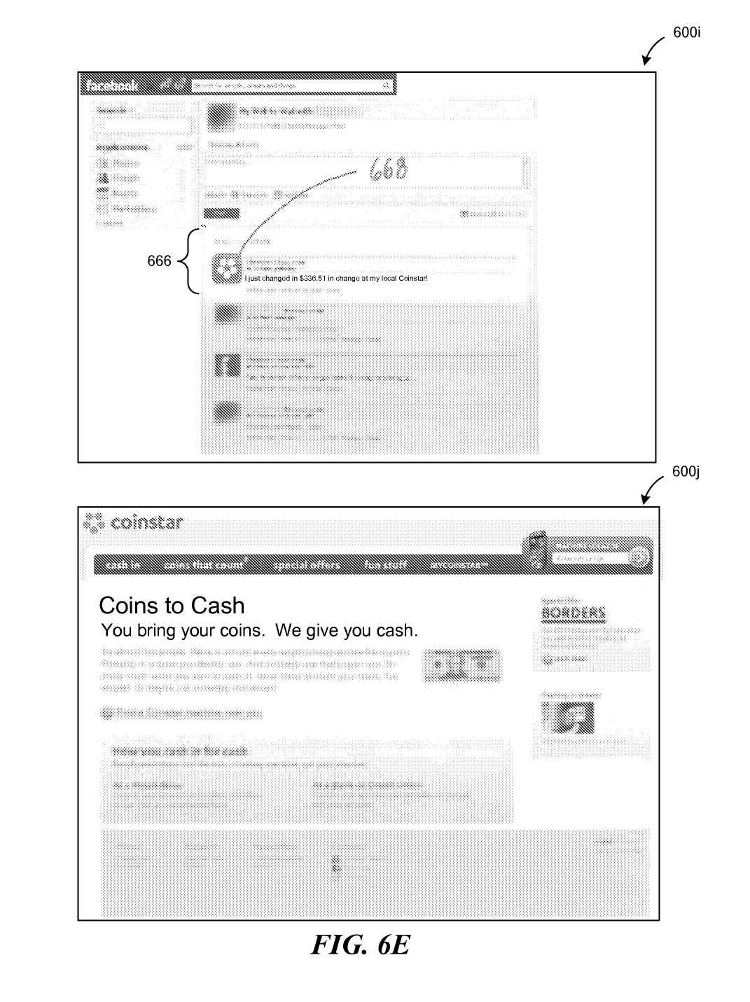

FIGS. 6A-6E illustrate a series of display pages 600a-600j suitable for implementing various aspects of a method for sharing the user's experience at the kiosk 100 with one or more other people (e.g., “friends”) via a social media website, such as Facebook®, Twitter®, etc, in accordance with embodiments of the present technology. Referring first to FIG. 6A, for example, the display page 600a provides the user with three options: a “log-in” button 602 enabling the user to log-in to a social media account, a Coinstar Account, or other account (such as PayPal®), etc.; a “continue” button 614 that takes the user to the marketplace; and a “start” button 616 that enables the user to begin counting deposited coins. If the user wishes to log-in to a social media website, the user selects the log-in button 602 which brings up the display page 600b. The display page 600b includes a plurality of icons or buttons that enable the user to select which account they wish to log-in to. For example, a “Coinstar” button 604 enables the user to log-in to their Coinstar® account, while a “Facebook” button 602 allows the user to log-in to a Facebook® account and a “Twitter” button 608 allows the user to log-in to a Twitter® account. If the user wishes, they can return to the home screen by depressing a “back” button 610. After selecting a particular account, the user can then log-in to that account by depressing or otherwise selecting a “log-in” button 612.

FIG. 6B illustrates a log-in display page 600c and an account landing display page 600d. The display page 600c is presented after the user selects the log-in button 612 of the display page 600b described above. The user enters their account ID (e.g., their Facebook® ID) in an “account” field 626, and their password in a “password” field 628. After entering this information, the user selects a “submit” button 630 which brings up the display page 600d. The display page 600d includes a social layer 618 which features the most recent transactions of both the user and the user's “friends” (e.g., other people who have access to the user's social website). More specifically, the social layer 618 lists the dates of the transactions (e.g., transactions with the kiosk 100) in a first column 620, the type of transaction in a second column 622, and the amount of the transaction in a third column 624. In addition, the display page 600d provides a message field 636 and an associated icon which enables the user to input and send a message (e.g., via a Tweet) to their friends via their Twitter® account.

FIG. 6C illustrates a counting display page 600e and a marketplace display page 600f. The counting page 600e is displayed to the user in response to the user selecting the “count coins” button 634 on the display page 600d, and includes a count field 636 that displays a running count of the user's coins counted by the kiosk 100. The user can also—elect to put in their money in and have it counted before going to the marketplace. The display page 600e also includes an array of denomination fields 638 which display the numbers of dollars, half-dollars, quarters, dimes, nickels and pennies counted by the machine. The final total is displayed in a “total” field 642 and information regarding other peoples (e.g. friends) prior coin counting experiences can be displayed in an information field 640 (e.g., a Tweet® field). For example, the field 640 enables users to share their coin count values with their friends and compete for, e.g., the highest coin pour value. As discussed above, the marketplace page 600f can include an array of purchase options 646 which the user can select for purchasing with all or a portion of the coin value. The display page 600f includes a drop-down field 644 which enables the user to sort the options by popularity, by favorites, or the user could also request that all options be displayed. In one embodiment, the placement of different options is based on the user's social network and/or selection of a special icon. In addition to these purchase options, the user may also elect to get cash by selecting a “get cash” button 648. After the user has selected a desired transaction, they can begin inserting bills by selecting a “bill” button 650 if they so desire, or they can begin counting coins by selecting a “coins” button 652. Alternatively, the user can elect to end their session by pressing an end button 654.

FIG. 6D illustrates a purchase confirmation display page 600g and an opt-in display page 600h. The display page 600g indicates that the user's selected transaction (e.g., receiving an iTunes® gift card 656) was successfully accomplished. By selecting an appropriate button, the user can receive the gift card and/or a corresponding digital receipt. Moreover, the user may elect to select a “posting” button 662 to post the results of their transaction to their “profile” or other portion of a social media website. If the user has money remaining in the machine, they can select another product in the marketplace. The user can return to the marketplace by selecting a back button 658, or end their session by selecting an end button 660. As shown on the Opt-in display page 600h, selecting the posting button 662 enables the user's transaction to be displayed as a “wall post” on the selected social media website.

FIG. 6E illustrates a social media webpage 600i and an associated product/service provider webpage 600j. In the illustrated embodiment, the display pages 600i and 600j can be displayed on computers remote from the kiosk 100, such as a personal user computer, handheld device, etc. The display page 600i can be at least generally similar in structure and function to one or more known social media web pages (e.g., such a Facebook® webpage). After the user has requested that their transaction be posted on their webpage, the associated information can be displayed on a portion of the webpage (e.g., on a portion of a “social wall” 666) along with an icon 668 or other graphic associating the transaction with the kiosk operator (e.g., Coinstar, Inc.) Any visitor to the webpage 600 can then select the kiosk operator icon 668, and this will take the visitor to the kiosk operator website, as shown by the display page 600j. Thus, by posting the transaction on the user's social media webpage, other potential users can review the transaction and easily access the coin counting service provider's website to get important information such as location of nearby machines, as well as information about the various products and services offered by the various kiosks.

Various embodiments of the display pages 600a-600j described above provide a personalized automated retail shopping experience through integration with social networks, allowing the user to share their individual experiences at the kiosk, and compete with “friends” virtually. Integration of the user log-in with preferred social media websites enables kiosk operators (e.g., coin counting kiosk operators, etc.), for example, to integrate specific information about their products and services with information provided on the social media site when the user logs-in at the kiosk. If the user logs-in with their social media web site credentials, a “friends” list can be retrieved and information regarding the friends' interactions with the automated retail machine (e.g., a coin counting machine) can be displayed for comparison and friendly competition among the friends, thereby encouraging increased usage of the automated retail machine. Social network friends' previous transactions and interactions can also be displayed. Also, users' experiences at the kiosk, such as ordering of products and services in the marketplace, can be automatically customized with information obtained from the social network. Additionally, these embodiments enable users to publish information on the social media site automatically (with/without user edits).

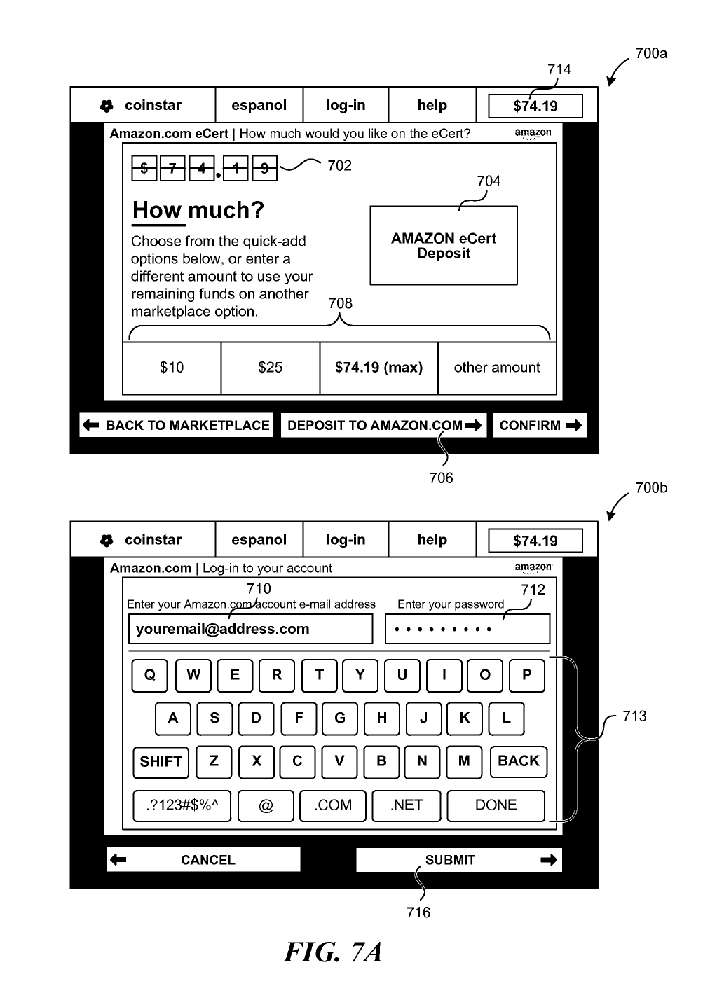

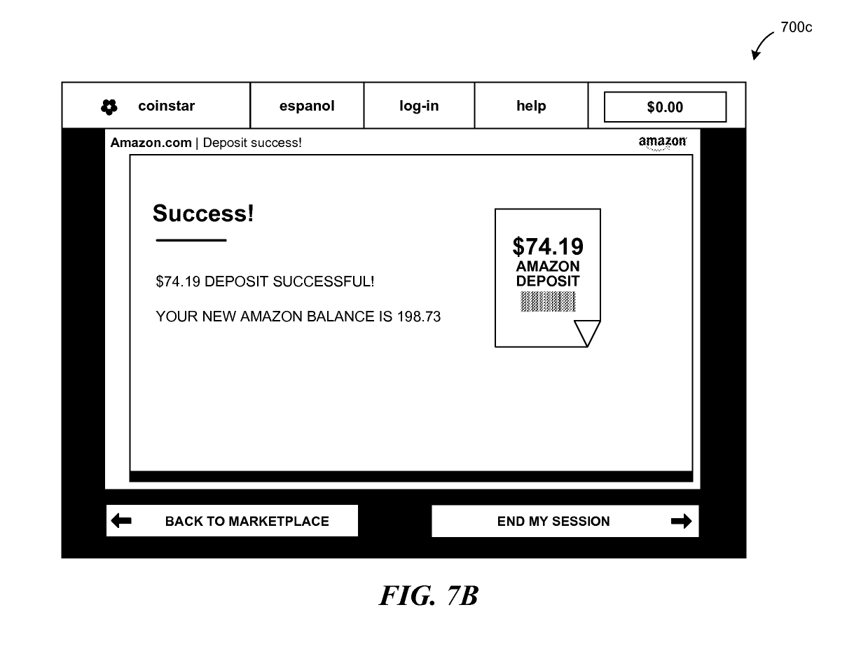

FIGS. 7A and 7B illustrate representative display pages 700a-700c that enable a user to deposit funds directly into an online account (e.g., an online shopping account 704) from a kiosk (e.g., the kiosk 100 described above) in accordance with an embodiment of the present technology. Referring first to FIG. 7A, the display page 700a includes a “count” field 702 that displays the total value the user wishes to deposit into the online account. The display page 700 further includes an array of dollar amount fields 708 which allow the user to select a preset dollar amount (e.g., $10 or $25), the total value of deposited coins, or another amount for transferring to the account. The dollar amount is not limited to the various amounts shown in the fields 708, and can include other amounts, other forms of currency, currency from other countries, other denominations, etc. After selecting a dollar amount, the user can direct deposit the funds by selecting a “deposit” button 706, which takes the user to the display page 700b. The display page 700b includes an account email address field 710 and a password field 712. After the user has entered the requested information in these fields using, for example, a touchpad 713, the user can submit the deposit request by selecting a “submit” button 716. After selecting the submit button 716, the display page 700c is presented which indicates to the user that the desired amount was successfully deposited into the selected online account. The user may also log in to the online account before they select an amount for deposit. In addition to logging in to the account in the manner described above with reference to the display page 700b, the user can also connect to the account in various other ways, including through, for example, a kiosk operator account, by using their phone number and a PIN, etc.

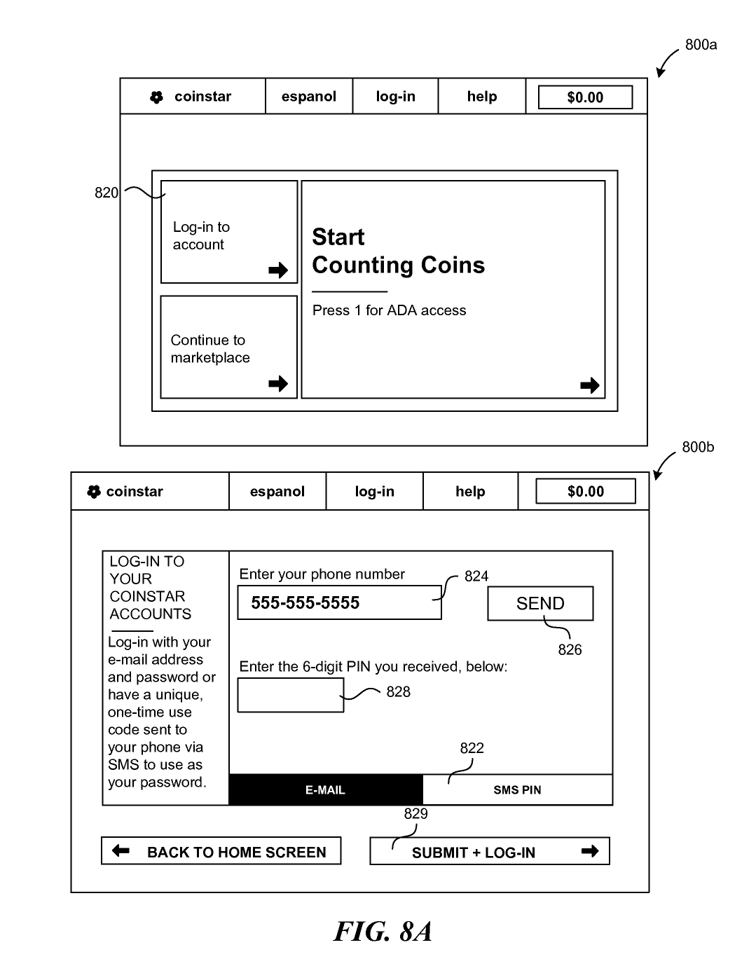

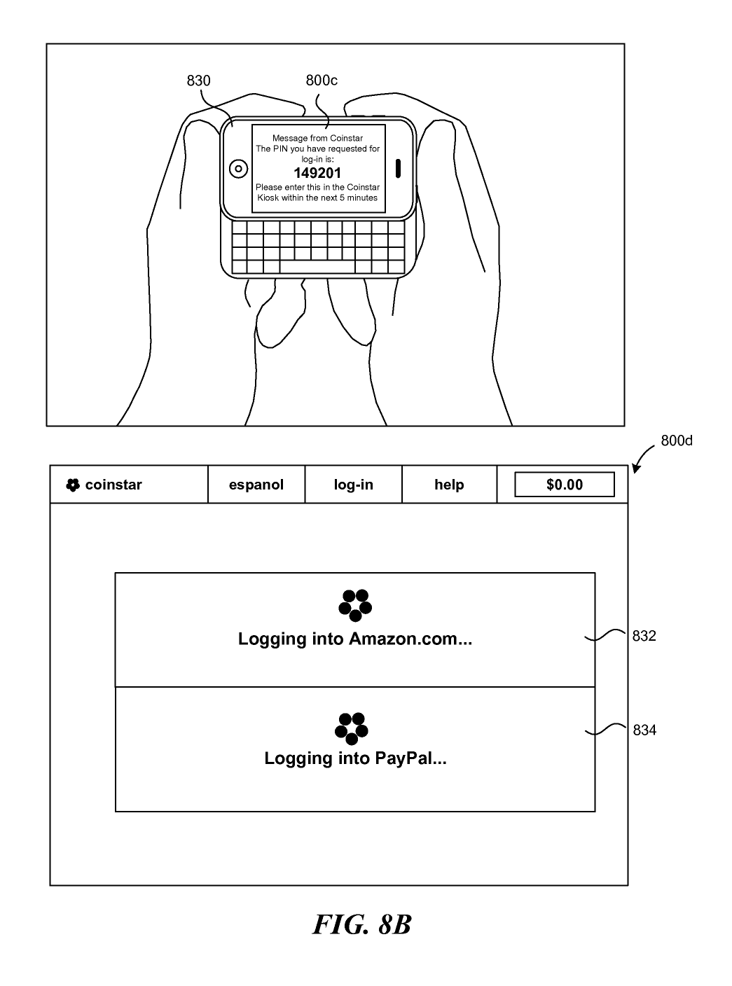

FIGS. 8A and 8B illustrate representative display pages 800a-800d for logging in to an online account from a kiosk (e.g., the kiosk 100) in accordance with another embodiment of the present technology. In the illustrated embodiment, the display pages 800a, 800b and 800d can be displayed on the kiosk 100, while the display page 800c can be displayed on the user's cell phone, smartphone, or other handheld device. Referring first to the display page 800a, the user selects a “log-in” button 820 to bring up the display page 800b and begin the log-in process. If the user wishes to log-in using their cell phone number (rather than, e.g., an email address), the user selects an “SMS PIN” button 822, and then enters their phone number in a phone number field 824. The user can then select a send button 826, which causes a one-time use password to be sent to the user's handheld device 830, as shown by the display page 800c. The user then reads this single-use password from the display page 800c and inputs it into a PIN field 828 on the display page 800b and presses a “send” button 829. Doing this logs the user in to one or more online accounts (e.g., Amazon.com®, PayPal®, etc.) and brings up the associated display page 800d. The user can then access a desired account by selecting the corresponding account icon or button 832 or 834.

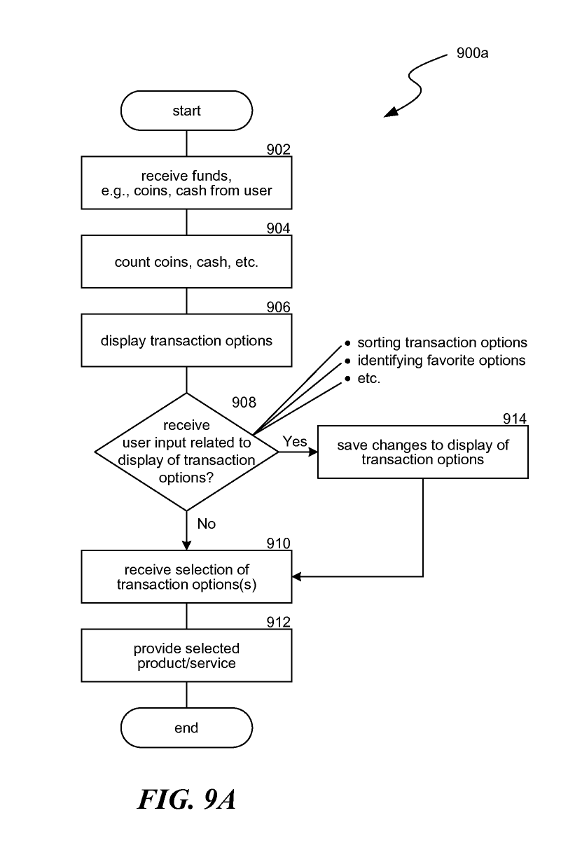

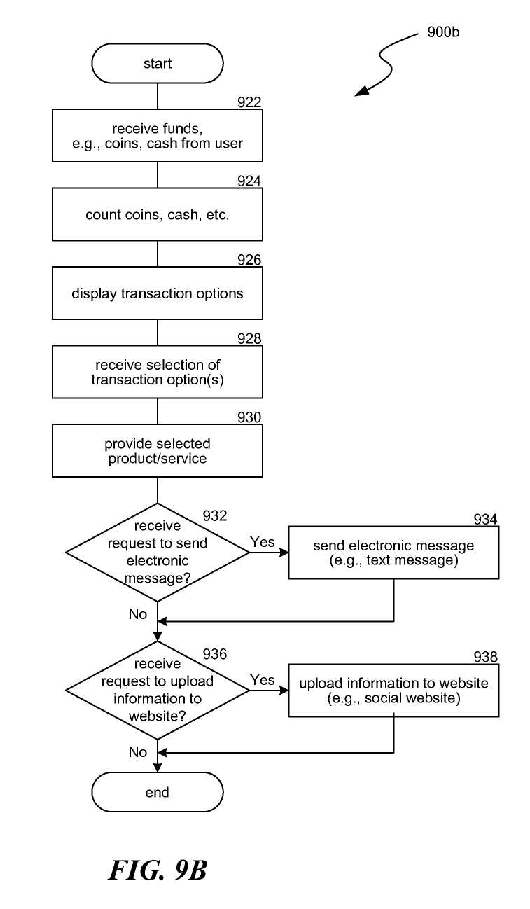

FIGS. 9A and 9B illustrate representative flow routines 900a and 900b, respectively, for performing various transactions with the consumer-operated kiosk systems described above. In various embodiments, the routines 900a, 900b can be performed by a kiosk processor (e.g., the processor 210 of the kiosk 100 described above with reference to FIG. 2) according to computer-readable instructions stored on a suitable computer-readable medium. Referring first to FIG. 9A, in block 902, the routine receives funds (e.g., a batch of loose coins, paper currency, and/or credit, etc.) from a user. In block 904, the routine counts the funds to determine a value, such as a total value. In block 906, the routine displays one or more transaction options (e.g., gift card, online account deposit/withdrawal, redeemable voucher, etc.) to the user via a suitable display device on the kiosk (e.g., the display device 106 described above with reference to FIGS. 1 and 2). In decision block 908, the routine checks to see if the user has provided any input (via, e.g., a suitable input device, such as the input device 102) related to the display of the various transaction options. For example, as described above the user can sort the various transaction options according to user preferences, identify favorite options, and/or provide other input with respect to the various available transaction options. Such input can change the visual display and/or arrangement of the options. If the routine receives user input related to the display of the transaction options in decision block 908, then the routine proceeds to block 914 and saves the changes to the display so that the next time the user logs in or otherwise accesses their information on the kiosk or another kiosk in the network, the changed set of transaction options will be displayed to the user. Alternatively, if the user does not provide any changes to the display of transactions options, the routine proceeds to block 910 and receives a selection of one or more transaction options from the user for application of the user's funds. In block 912, the kiosk provides the product and/or service associated with the selected transaction option to the user and the routine ends.

Referring next to FIG. 9B, in block 922, the routine 900b receives funds from the user, and in block 924 the routine counts the funds to determine, e.g., a total value. In block 926, the routine displays transaction options to the user. As described above with reference to FIG. 9A, if the user has personalized or otherwise changed the display of transaction options to reflect the user's preferences, the user-specific arrangement of transaction options can be displayed to the user when the user logs in or otherwise provides identification to the kiosk. In block 928, the routine receives a selection of one or more transaction options from the user, and in block 930 the routine provides the corresponding product and/or service to the user. As described above with reference to, e.g., FIGS. 6A-6E, the routine can also display various graphics, icons, buttons, and/or other features that, when selected by the user via an input device, enable the user to automatically send an electronic message, such as a text message (e.g., a Tweet) to one or more third party computing devices/electronic addresses (e.g., handheld devices). The electronic message can include information related to the user's transaction (e.g., the amount of funds, the location, the type of transaction, etc.). In decision block 932, for example, the routine checks for a request to send an electronic message related to the transaction to one or more third party computing devices/users. If such a request is received, in block 934 the routine sends the electronic message. In addition or alternatively, in decision block 936 the routine can receive a request from the user to upload information related to the transaction to a remote website for display, such as a social website (e.g., Facebook®) for viewing by third party visitors to the user's webpage. If the user selects this option, then in block 938 information related to the transaction (e.g., the amount of the transaction, the location of the transaction, the selected purchase option, etc.) can be uploaded onto the website. After block 938, the routine ends. Although the routines 900a and 900b may have been described above in particular orders, the various steps can be implemented in other orders, and various steps can be added and/or omitted from the routines without departing from the present technology. Accordingly, the routines described herein are not limited to the particular representative embodiments described above.

One skilled in the relevant art will appreciate that the concepts of the invention can be used in various environments other than the Internet. For example, the concepts can be used in an electronic mail environment in which electronic mail forms and messages perform the various communications and information exchanges. In general, a display description may be in WPF format, HTML format, email format, or any other format suitable for displaying information (including character/code-based formats, algorithm-based formats (e.g., vector generated), and bitmapped formats).

Also, various communication channels may be used, such as a local area network, wide area network, or a point-to-point dial-up connection instead of the Internet. The server system may comprise any combination of hardware or software that can support these concepts. In particular, a web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.).

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present technology. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A consumer operated coin counting kiosk comprising:
a coin input region configured to receive a plurality of coins from a user;
a coin counting apparatus configured to receive the coins from the coin input region and count the coins to determine a coin value;
a display screen; and
one or more display pages for presentation via the display screen, wherein the one or more display pages present a plurality of transaction options to the user for use of the coin value, and wherein the one or more display pages enable the user to personalize the presentation of the transaction options and save the personalized presentation for subsequent display to the user via the kiosk.

2. The coin counting kiosk of claim 1 wherein the one or more display pages enable the user to sort the transaction options into a desired arrangement and save the desired arrangement for subsequent display to the user via the kiosk.

3. The coin counting kiosk of claim 1 wherein the one or more display pages enable the user to identify favorite transaction options and save the identified favorite options for subsequent display to the user via the kiosk.

4. The coin counting kiosk of claim 1 wherein the kiosk is a first kiosk, and wherein the one or more display pages enable the user to sort the transaction options into a desired arrangement and save the desired arrangement for subsequent display to the user via a second coin counting kiosk.

5. The coin counting kiosk of claim 1 wherein the display screen is a first display screen, and wherein the kiosk further comprises a network connection operably connecting the kiosk to a remote database, wherein the one or more display pages enable the user to sort the transaction options into a desired arrangement, wherein the desired arrangement is saved in the remote database via the network connection for display to the user via a second display screen of a remote processing device.

6. The coin counting kiosk of claim 1 wherein the plurality of transaction options include purchasing a gift card.

7. The coin counting kiosk of claim 1 wherein the plurality of transaction options include transferring money to an online account.

8. The coin counting kiosk of claim 1, further comprising:
a processor; and
a computer readable medium containing instructions causing the processor to display the one or more display pages via the display screen.

9. A consumer operated coin counting kiosk comprising:
a coin input region configured to receive a plurality of coins from a user;
a coin counting apparatus configured to receive the coins from the coin input region and count the coins to determine a coin value;
a network connection enabling the kiosk to exchange information with a remote website;
a display screen; and
one or more display pages for presentation via the display screen, wherein the one or more display pages present a plurality of transaction options to the user for use of the coin value, and wherein the one or more display pages enable the user to upload information related to the coin value to the remote website via the network connection.

10. The coin counting kiosk of claim 9 wherein the one or more display pages further enable the user to upload information related to at least one of the transaction options to the remote website.

11. The coin counting kiosk of claim 9 wherein the remote website is a social website that enables the user to display information for viewing by third party users of the social website.

12. The coin counting kiosk of claim 9 wherein the remote website is an online social networking service that enables its users to send and receive text-based messages.

13. The coin counting kiosk of claim 9 wherein the one or more display pages further enable the user to automatically send a text-based message related to the coin value to a remote computing device via the network connection.

14. A method for operating a coin counting machine, the method comprising:
receiving a plurality of coins from a user;
counting the coins to determine a value;
displaying a plurality of options for which the user can apply the coin value;
receiving input from the user, wherein the input changes the display of the options from a first display to a second display; and
saving the second display.

15. The method of claim 14 wherein the coin counting machine is a first coin counting machine, and wherein the method further comprises:
receiving a second plurality of coins from the user in a second coin counting machine;
counting the second plurality of coins to determine a second value; and
presenting the second display of options to the user.

16. A computer-readable medium including instructions configured to cause a processing device to present a display page on a coin counting machine, the display page comprising:
a coin value field; and
a user selectable graphic, wherein user selection of the graphic enables the user to send information related to the coin value from the kiosk to a social networking website.

17. The computer-readable medium of claim 16 wherein user selection of the graphic enables the user to automatically send a text message to one or more third party computing devices.
